(19) United States
(12) Patent Application Publication
(10) Pub. No.: US 2002/0134830 A1
(43) Pub. Date: Sep. 26, 2002

(54) Method and system for mediating content exchange

(75) Inventors: Harvey Golub, Teaneck, NJ (US); Peter B. Ritz, Meadowbrook, PA (US)

Correspondence Address: Daniel H. Golub, 1701 Market Street, Philadelphia, PA, 19103, US

(73) Assignee: Peter Ritz and Harvey Golub

(21) Appl. No.: 10/142,195

(22) Filed: May 9, 2002

Related U.S. Application Data
(63) Continuation-in-part of application No. 09/971,115, filed on Oct. 4, 2001.
(63) Continuation-in-part of application No. 09/971,321, filed on Oct. 4, 2001.
(63) Continuation-in-part of application No. 09/971,369, filed on Oct. 4, 2001.
(63) Continuation-in-part of application No. 09/971,093, filed on Oct. 4, 2001.
(63) Continuation-in-part of application No. 09/236,176, filed on Jan. 25, 1999.
(63) Continuation-in-part of application No. 09/310,355, filed on May 12, 1999, now abandoned.
(63) Continuation-in-part of application No. 09/951,361, filed on Sep. 13, 2001.
(60) Provisional application No. 60/327,418, filed on Oct. 4, 2001.
(60) Provisional application No. 60/252,906, filed on Nov. 27, 2000.

(51) Int. Cl. G06F 17/00

(52) U.S. Cl. 235/375

(57) ABSTRACT

Electronic content is associated with tangible content embodied in a tangible information medium. A code is established for publication in association with the tangible content. Electronic content information and at least one content option associated with the code are received. The electronic content information includes a network address associated with the electronic content. A menu is maintained in association with the code. The menu includes at least one content option. A request that includes the code is received from a user. Based on the request, the user is connected with the menu. A choice including a selection of one of the content options is received from the user. Based on the choice, the user is directed to the network address.

### CROSS REFERENCE TO RELATED APPLICATIONS

This application claims priority to U.S. Provisional Patent Application Serial No 60/327,418 and is a continuation-in-part of patent application Ser. Nos. 09/971,115; 09/971,321; 09/971,369; and 09/971,093, each of which claims priority to U.S. Provisional Patent Application Serial No. 60/252,906 and each of which is a continuation-in-part of U.S. patent application Ser. Nos. 09/236,176; 09/310,355; and 09/951,361.

### FIELD OF THE INVENTION

The present invention relates generally to information exchange and is directed more specifically to mediating the exchange of information.

### BACKGROUND OF THE INVENTION

Each day publishers issue books, magazines, newspapers, and other tangible media that become obsolete—if not immediately upon publication, shortly thereafter. This obsolescence may be attributable to a variety of factors. For example, mere publication of a news story may provoke a reaction to the story which, naturally, cannot be printed retroactively within the already published document. There may also be errors in the publication which escape review prior to distribution. In another example, new information regarding the published subject matter may become available after publication.

Alternatively, certain publications are intended to provoke interaction with a reader. Examples of such publications include advertisements. Traditionally, consumers have been unable to interact with an advertiser through the actual advertisement. Thus, for example, where a consumer is interested in buying a new camera that is advertised in a photography magazine, the consumer must independently locate a seller of that camera. Even where a vendor name, address, and telephone number, or Internet address are provided in the advertisement, the consumer must either remember the vendor information, jot it down, or physically clip and carry the ad for some period of time.

Many publishers of tangible media also maintain Internet web sites that supplement their printed products. It remains difficult and time consuming, however, for a reader of the tangible media to locate the supplemental information pertaining to a particular article. Locating the appropriate web site may require remembering long and complicated URLs, tunneling through a mobile device menu, following complicated instructions or surfing through web sites.

Furthermore, tangible media publishers would benefit from a method and system which may allow them to better understand what readers actually read. Tracking hits to a particular web site is commonplace. Yet, it has been difficult, if not impossible, to link the volume of hits at a particular Internet site to content in a tangible media that generated the hits. Obtaining such information would also enable media publishers to increase distribution of their existing content, provide opportunities to expand online subscriptions, and increase value to advertisers.

The present invention addresses these issues and meets the needs left unmet by prior art systems.

### SUMMARY OF THE INVENTION

The present invention is directed to a method and system for associating electronic content with tangible content embodied in a tangible information medium. A code is established for publication in association with the tangible content. Electronic content information and at least one content option associated with the code are received. The electronic content information includes a network address associated with the electronic content. A menu is maintained in association with the code. The menu includes at least one content option. A request that includes the code is received from a user. Based on the request, the user is connected with the menu. A choice including a selection of one of the content options is received from the user. Based on the choice, the user is directed to the network address.

### BRIEF DESCRIPTION OF THE FIGURES

FIG. 1 illustrates a preferred embodiment of a system of the present invention;

FIG. 2 illustrates a preferred embodiment of a user interface for managing codes used in connection with a preferred embodiment of the present invention;

FIG. 3 illustrates a preferred embodiment of a user interface for creating menus used in connection with a preferred embodiment of the present invention;

FIG. 4 illustrates an exemplary article with a code printed in association therewith in accordance with a preferred embodiment of the present invention;

FIG. 5A illustrates an exemplary menu displayed on a user device in accordance with a preferred embodiment of the present invention;

FIG. 5B illustrates an exemplary menu displayed on the screen of a personal computer in accordance with a preferred embodiment of the present invention;

FIG. 5C illustrates an exemplary interface for sending an email message relating to tangible content in accordance with a preferred embodiment of the present invention;

FIG. 5D illustrates an exemplary interface presenting information relating to tangible content in accordance with a preferred embodiment of the present invention;

FIG. 5E illustrates an exemplary interface for receiving breaking news on a topic related to tangible content in accordance with a preferred embodiment of the present invention;

FIG. 5F illustrates an exemplary interface presenting information on a company perspective on a topic related to tangible content in accordance with a preferred embodiment of the present invention;

FIG. 5G illustrates an exemplary interface presenting information about an author of tangible content in accordance with a preferred embodiment of the present invention;

FIG. 5H illustrates an exemplary letter to the editor of tangible content in accordance with a preferred embodiment of the present invention;

FIG. 5I illustrates an exemplary interface presenting a menu relating to tangible content in accordance with a preferred embodiment of the present invention;

FIG. 5J illustrates an exemplary interface presenting a message board relating to tangible content in accordance with a preferred embodiment of the present invention;

FIG. 5K illustrates an exemplary interface presenting a chat room relating to tangible content in accordance with a preferred embodiment of the present invention;

FIG. 5L illustrates an exemplary interface presenting an offer to license tangible content in accordance with a preferred embodiment of the present invention;

FIG. 5M illustrates an exemplary interface presenting an option to receive additional information relating to tangible content in accordance with a preferred embodiment of the present invention;

FIG. 6A illustrates a code printed in association with an advertisement in accordance with a preferred embodiment of the present invention;

FIG. 6B illustrates an exemplary interface presenting a menu relating to tangible content in accordance with a preferred embodiment of the present invention;

FIG. 6C illustrates an exemplary interface presenting an option to buy a product advertised in tangible content in accordance with a preferred embodiment of the present invention;

FIG. 6D illustrates an exemplary interface presenting information about a product for purchase advertised in tangible content in accordance with a preferred embodiment of the present invention;

FIG. 6E illustrates an exemplary interface presenting information about where to purchase an item advertised in tangible content in accordance with a preferred embodiment of the present invention;

FIG. 7A illustrates a code printed in association with a classified advertisement in accordance with a preferred embodiment of the present invention;

FIG. 7B illustrates an exemplary interface presenting a menu relating to tangible content in accordance with a preferred embodiment of the present invention;

FIG. 7C illustrates an exemplary interface allowing a user to respond to a classified advertisement in accordance with a preferred embodiment of the present invention;

FIG. 7D illustrates an exemplary code printed in association with a classified advertisement in accordance with a preferred embodiment of the present invention;

FIG. 7E illustrates an exemplary interface presenting a menu relating to tangible content in accordance with a preferred embodiment of the present invention;

FIG. 8 illustrates an exemplary interface presented to a user when accessing the system of a preferred embodiment of the present invention;

FIG. 9 illustrates an exemplary data structure used for organizing data in accordance with a preferred embodiment of the present invention; and

FIG. 10 is a flow chart illustrating a preferred embodiment of a method of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention enables a user who observes a tangible medium to interact with the publisher of the tangible medium, and/or with a provider of electronic content related to the tangible medium, through use of a code (i.e., an identifier, such as a bar code, an RFID or other type of code) printed in association with the tangible medium and associated with the electronic content. In the preferred embodiment, a service provider facilitates this interaction by mediating the dialog between the user the publisher and/or the electronic content provider.

In a particular example, a user-content interaction may be provoked by an article published in a magazine that includes commentary about a particular business. The publisher of the magazine may procure (through a commercial transaction or otherwise) a bar code from the service provider and associate the bar code with the printed article. This association may be achieved by, for example, printing the code at the end of the article. Electronic content related to the printed article is associated with the printed article by associating the electronic content with the code and storing information representative of this association with the service provider in a registry. A reader of the article may then scan the bar code using, for example, a device that is connected to the Internet and transmit a signal representative of the bar code to the service provider. The service provider consults the registry and presents the user with a menu including a list of options associated with the code. The options may include, for example, receiving electronic information about the business's perspective on the article. Upon the user selecting the option to read the business's perspective, the user is connected to the perspective by way of, for example, a text message, an audio message, a video message, or any other electronic means for communicating the information.

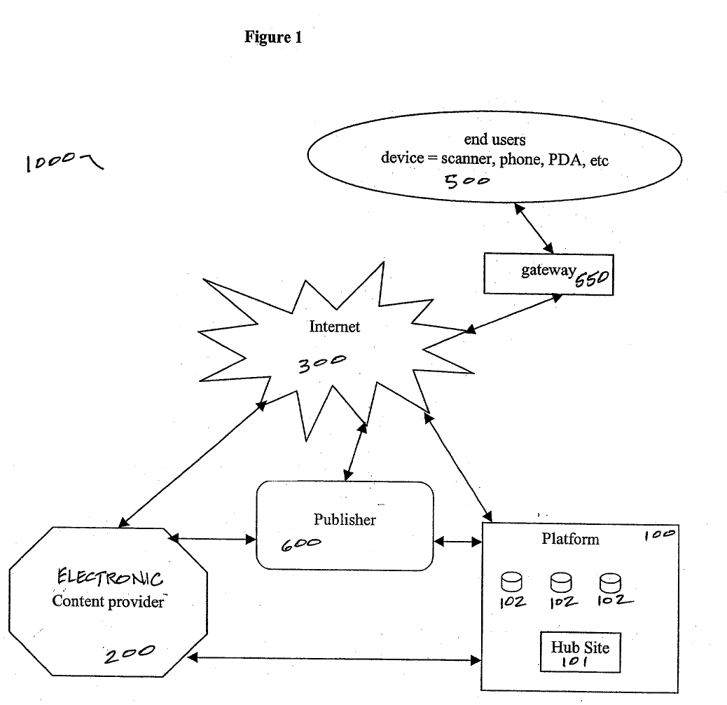

FIG. 1 illustrates a preferred embodiment of a system 1000 for carrying out the methods of the present invention. System 1000 includes a platform 100 (sponsored by the service provider), one or more content providers 200, a plurality of end users 500, and at least one publisher 600. End users 500, platform 100, content providers 200, and publishers 600 may connect to each other though a variety of different types of links to form a network 2000. For example, end users 500 may connect to platform 100 through the Internet 300, as may platform 100 to publisher 600 and content provider 200. Depending on the device used by end user 500, the communication from end user 500 may be routed through one or more gateways 550. In other embodiments, platform 100 may be connected to publisher 600 and to content provider 200 via a wide area network. Alternate configurations of the connections among end users 500 platform 100, publishers 600 and content providers 200 are possible, will be known to those skilled in the art, and are within the scope of the present invention. In some embodiments, one or more of the links between these various entities is wireless.

Platform 100 may be accessible to the end users 500 through a hub site 101 supported by platform 100. In a preferred embodiment, platform 100 is maintained and used by the service provider to, among other things, store data in database 102 and process data in accordance with the inventive method. The stored data may include the codes, the network address of electronic content associated with the codes, menu information associated with the codes, and publisher information.

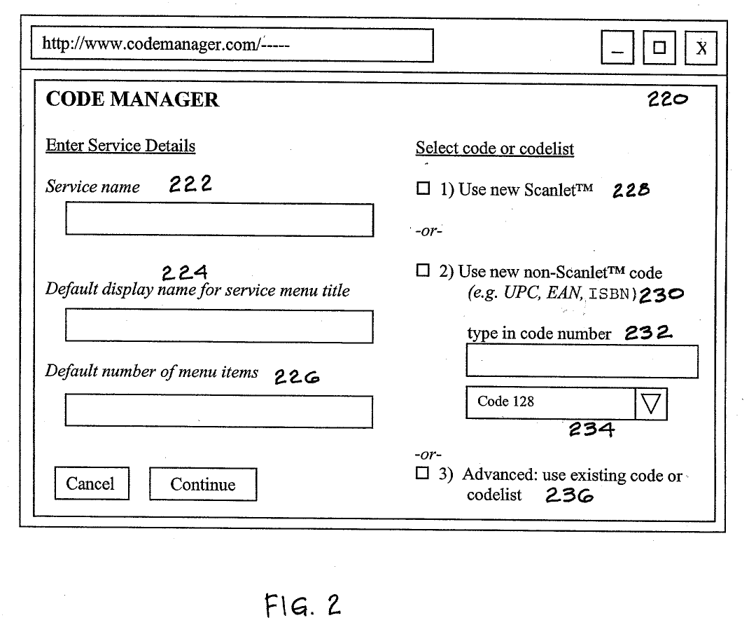

In an exemplary embodiment, a publisher (such as a newspaper or periodical publisher) obtains from the service provider a number of codes to be inserted into the printed medium. The process for activating or reconfiguring such codes is described with reference to FIG. 2. Using a user name and password, the publisher 600 accesses the platform 100 and navigates to code manager screen 220. From the code manager screen 220, the publisher 600 may enter service details for the purpose of managing one or more of the issued codes. For example, the publisher may define a service name 222 (such as “Lead Article”) that it will associate with a particular code. This service name may then be associated with a default display name 224, which may or may not differ from the service name. The default display name 224 is the title text that is presented to the user 500 when the user 500 uploads the code to platform 100. For example, the default display name may be the name of the particular lead article, such as “IPO for Company XYZ”. The publisher 600 may also enter a default number 226, which indicates the maximum number of menu items to be presented to user 500 for selection.

From screen 220, the publisher 600 also identifies the code to be associated with the entered service details. Where the code is newly activated, the publisher 600 may select indicator 228 to associate a newly activated custom code with the entered service details. In an alternate embodiment, the publisher 600 selects standard codes to be published in association with the printed medium, rather than custom codes issued by the service provider. Examples of standard codes include UPC, EAN, and ISBN codes. The publisher 600 may elect to use such standard codes by selecting indicator 230, entering the code in box 232, and selecting the type of standard code in box 234. In still other embodiments, the publisher 600 may associate the service details with a pre-existing code or code list by selecting indicator 236. Screen 250 may be used to edit service details that have been previously established for codes.

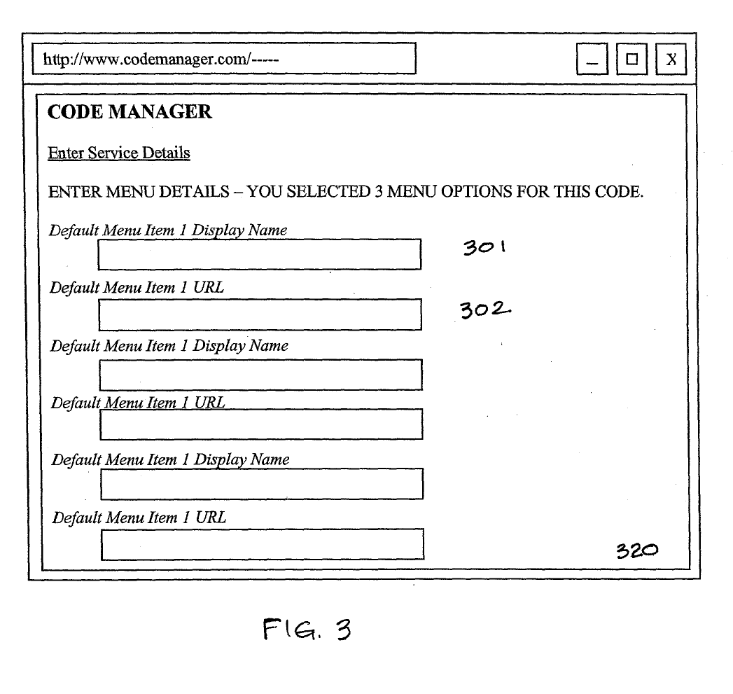

Once service details have been associated with a code, the code may be associated with a menu, the details of which may be entered at screen 320, as illustrated in FIG. 3. In this illustration, the publisher 600 has indicated that the menu associated with a particular service name and code will have up to three menu options. It will be appreciated that this number is exemplary and does not limit the scope of the invention. Any number of menu options may be provided. The menu options are labeled with display names 301. The publisher may then define a network address associated with each menu option by entering the network address (e.g., a URL) in box 302 corresponding to the display name 301. Where the menu item involves the sending of an e-mail, the menu item entered in box 302 is a command to launch an e-mail (e.g., mailto:info@abccompany.com). The display names entered will be presented to the user as menu items upon the user's entering the code. When the user selects a menu item, he will be connected to the network address specified as corresponding to the selected menu item.

In another embodiment, a publisher 600 may permit a third party to define the menu options and corresponding network addresses by, for example, providing a security key for the third party to access screens 220 and/or 320 of FIGS. 2 and 3, respectively. These third parties may be, for example, electronic content providers 200 who are interested in interacting with users regarding the tangible content. Thus, for example, where the electronic content provider 200 is an advertiser who engages the publisher 600 for the purpose of publishing an advertisement in the publication, the publisher may enable the advertiser to create a user experience (e.g., a menu) specific to the needs of the advertiser.

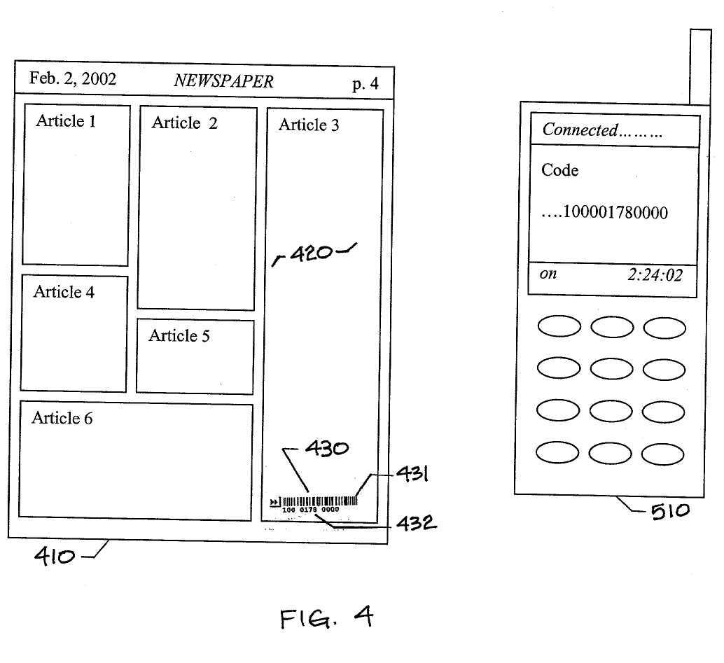

A user 500 who intends to use the inventive system may, in some embodiments, be required to pre-register with platform 100. For example, the user may be required to provide information such as the user's name, address, country of residence, and e-mail address, as well as user preferences, such as language preference, dietary restrictions or other custom value that may be used in defining the user's context. An exemplary user experience employing the inventive system is illustrated with reference to FIG. 4. In this example, a newspaper publisher has acquired one or more codes from the service provider; has associated one of the codes 430 with information 420 in a tangible medium (e.g., newspaper 410) by printing the code 430 in proximity to the information 420; and has enabled the code 430 as described with reference to FIGS. 2 and 3. While reading an article 420 in the newspaper 410, the user becomes aware of the code 430. In the illustrated embodiment, the code includes machine readable information 431 and human readable information 432. In other embodiments, the code 430 may be in only one of human readable or machine readable format.

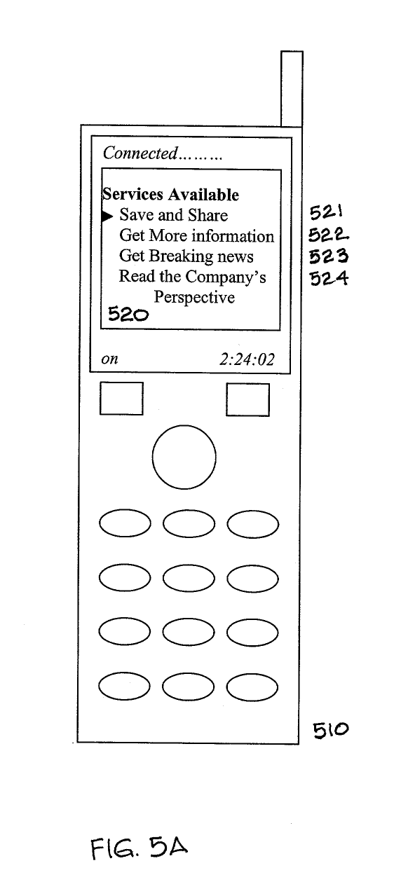

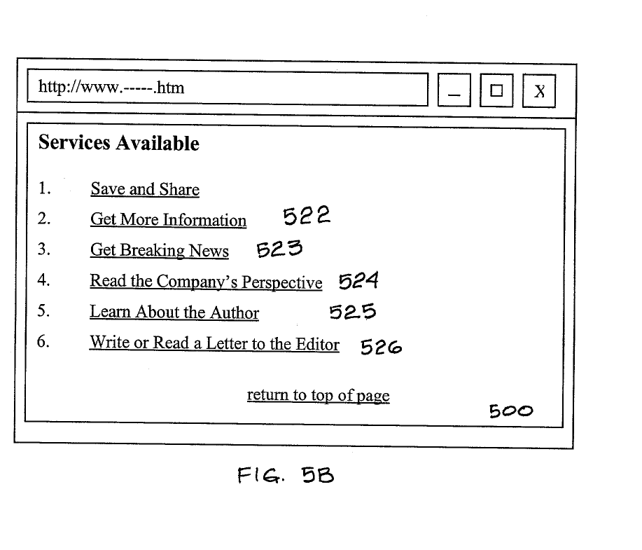

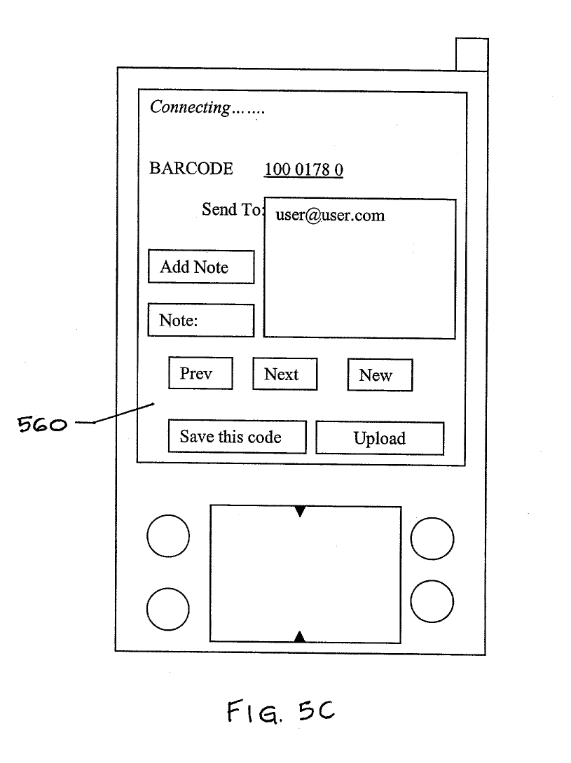

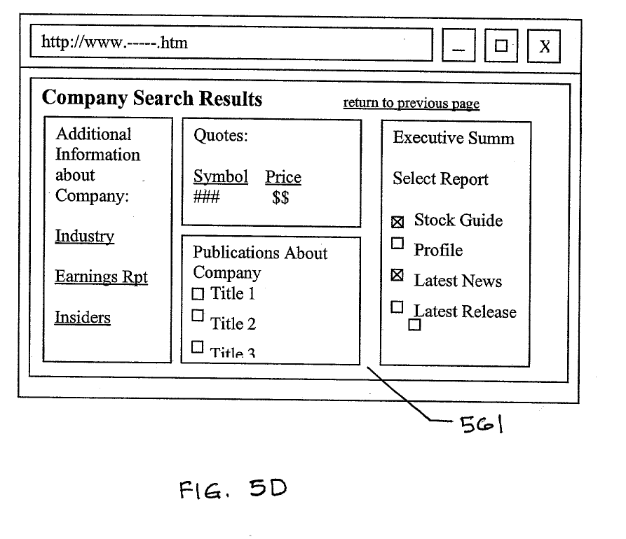

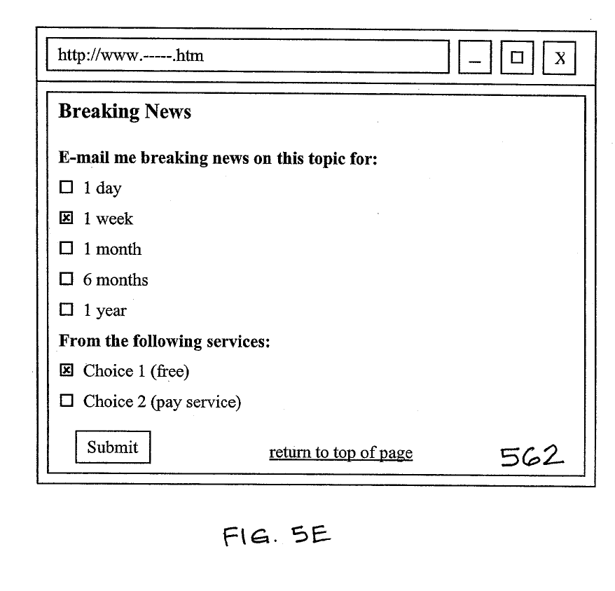

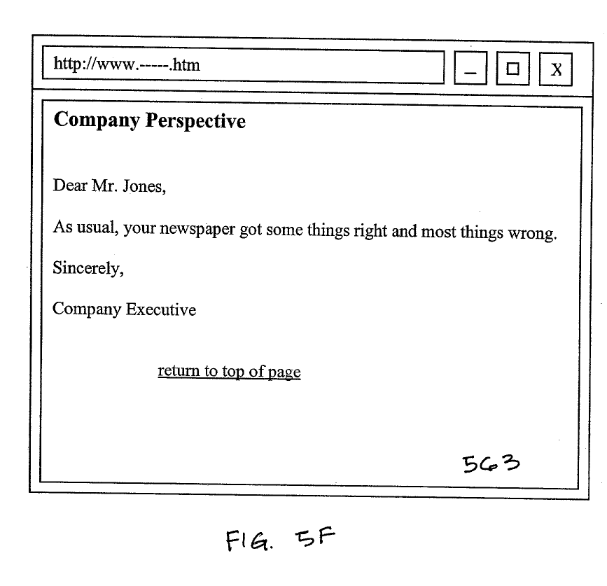

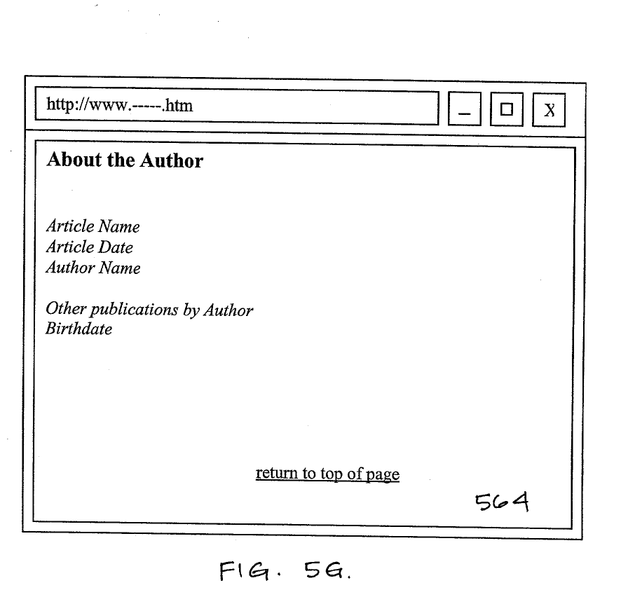

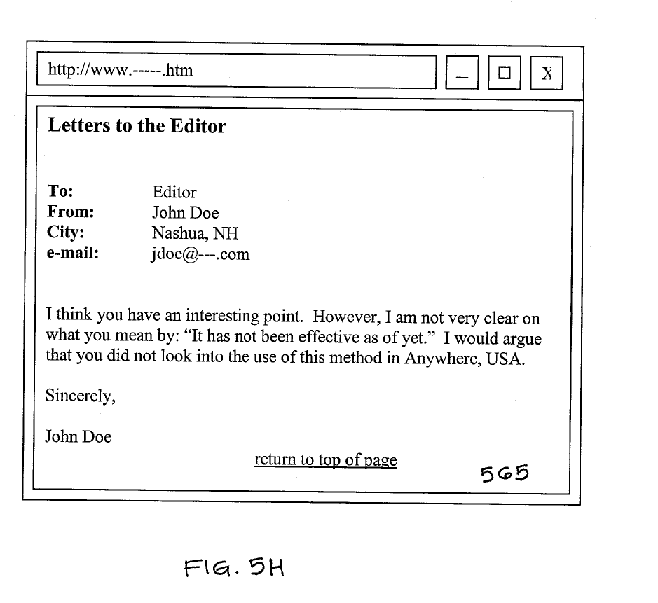

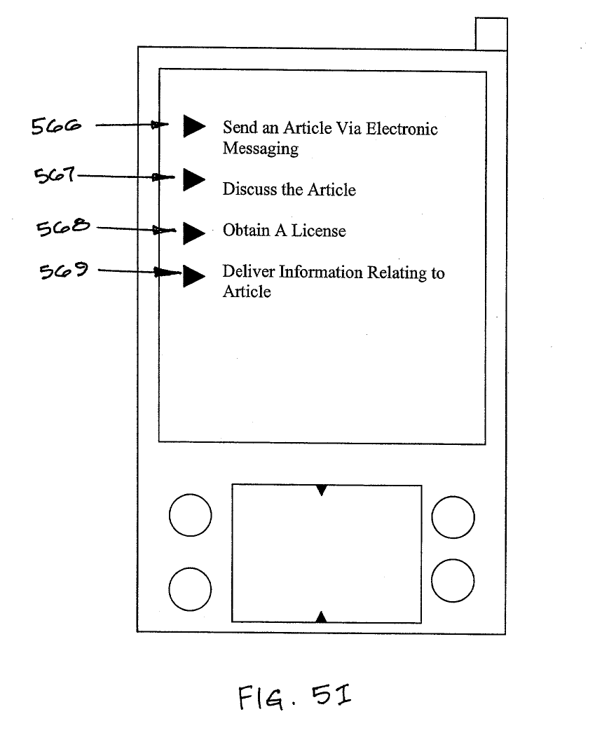

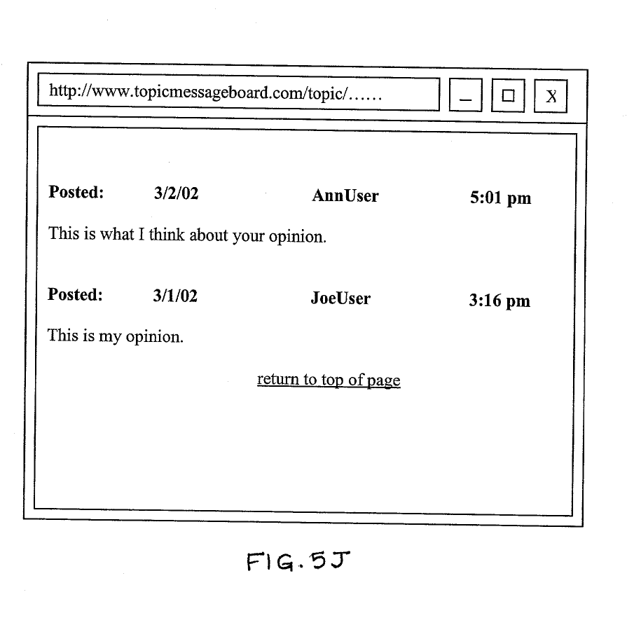

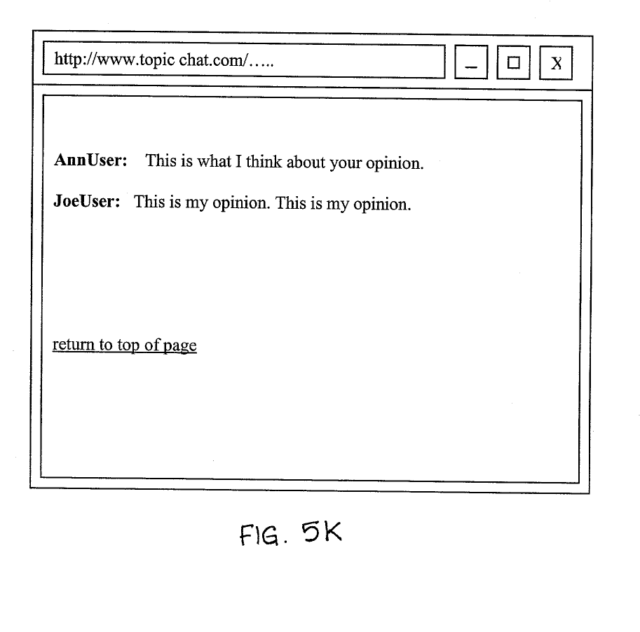

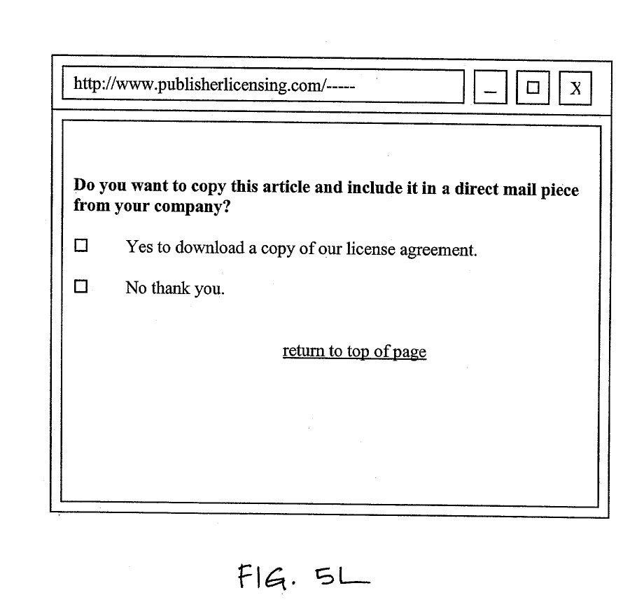

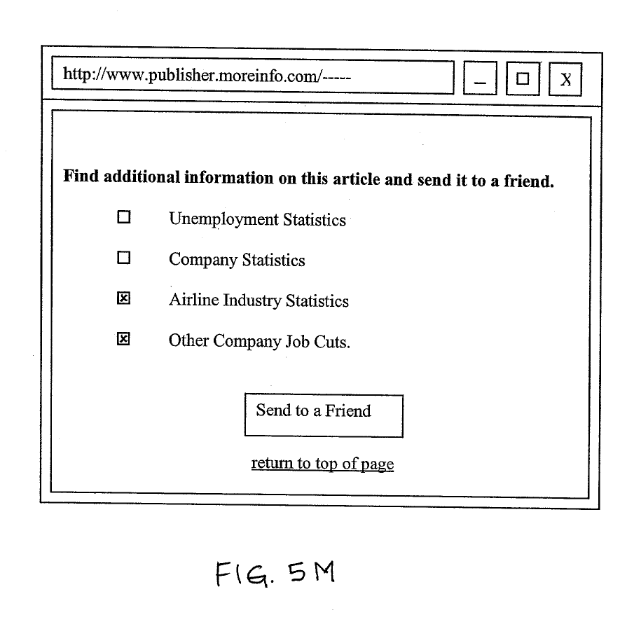

With reference to FIG. 5A, the user manually enters the human readable information into a device (such as wireless mobile telephone 510), which maintains a live connection to platform 100. Alternative methods of obtaining the code for transmission to platform 100 are possible depending on the device being used and the desire of the user. For example, the code may be obtained by scanning the machine readable information 431. The scanned information may be saved and uploaded to platform 100 at a later time. Alternatively, if the scanning device is connected to platform 100 when the machine readable code is scanned, the code is automatically uploaded to platform 100. Further, while the example in FIG. 5A depicts device 510 as an Internet-enabled mobile telephone, many different types of devices can be used in connection with the present invention, such as personal computers, ordinary telephones, RIM, PDAs, pagers, mobile scanners, and Internet-enabled phones equipped with scanners.

Upon the user manually entering the code into device 510 and transmitting it to platform 100, platform 100 resolves the code, identifies the menu associated therewith, and automatically presents the user with menu 520 relating to the article 420 (of FIG. 4).

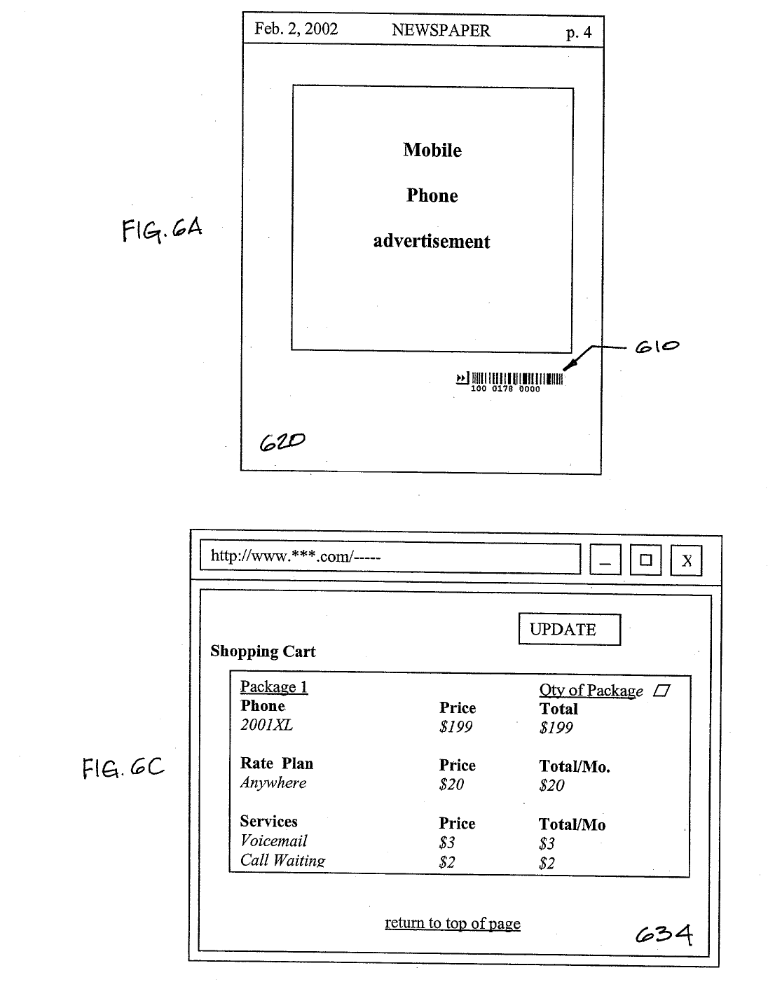

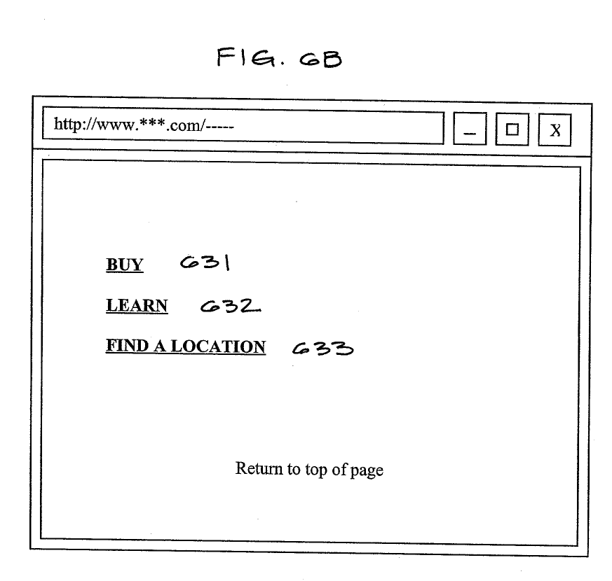

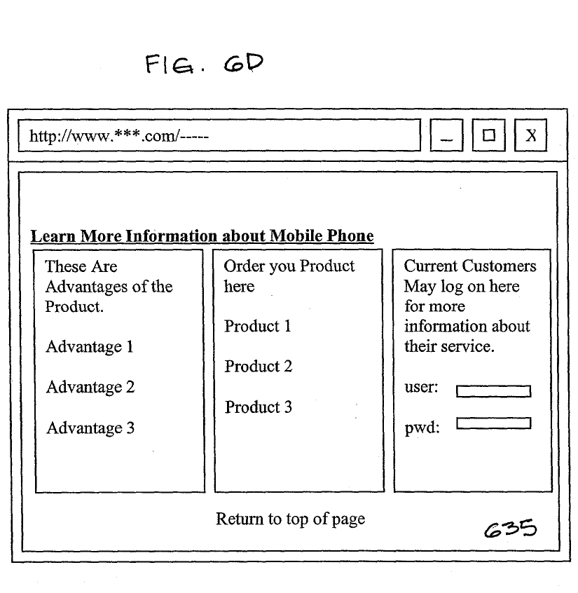

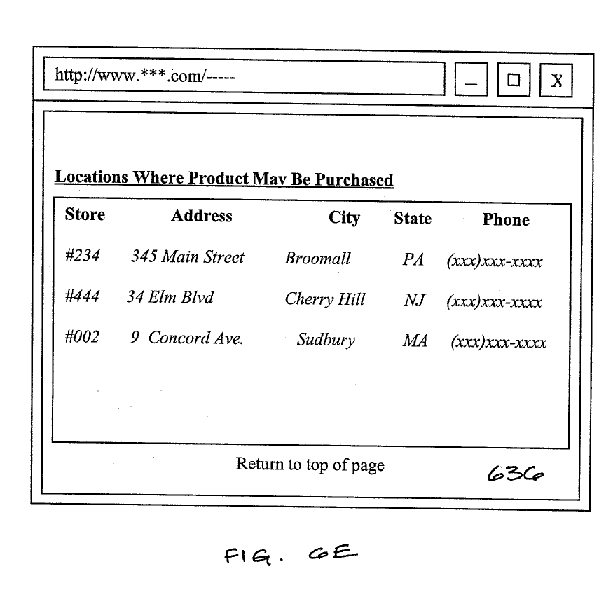

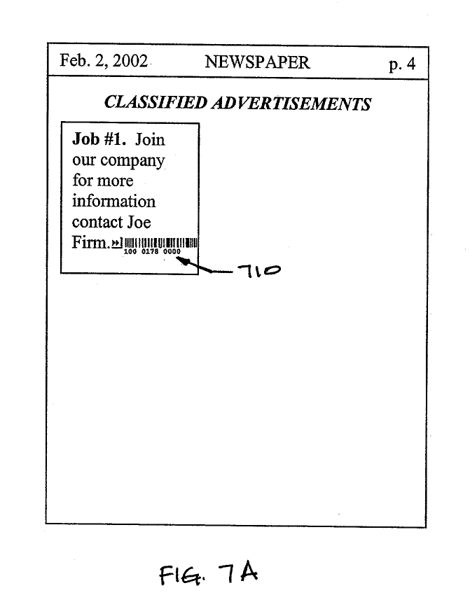

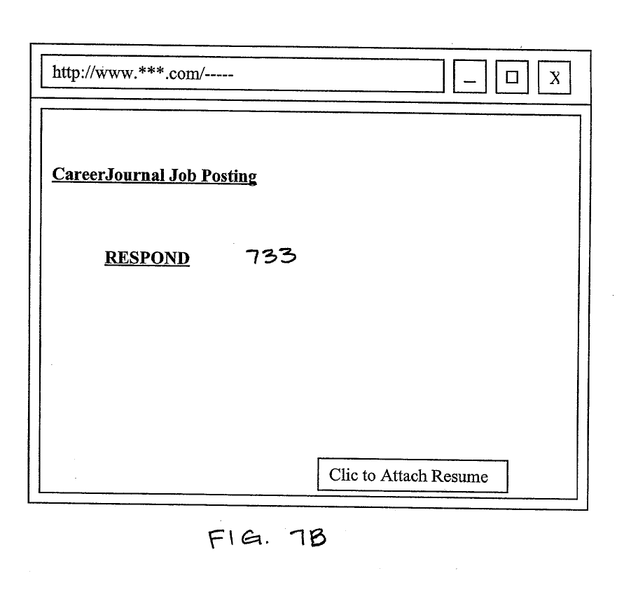

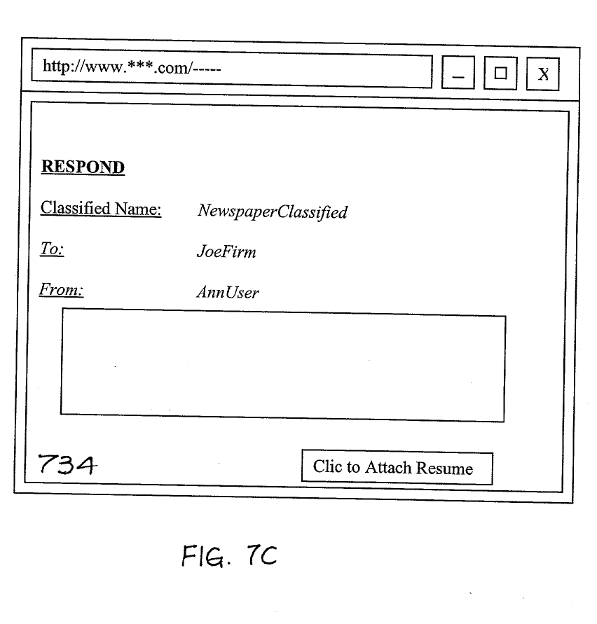

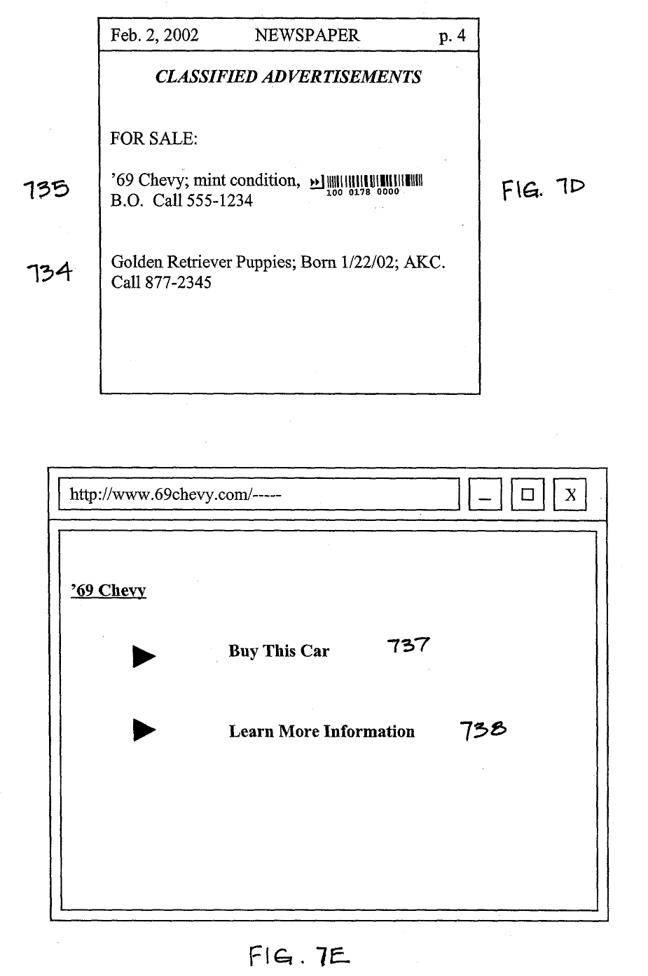

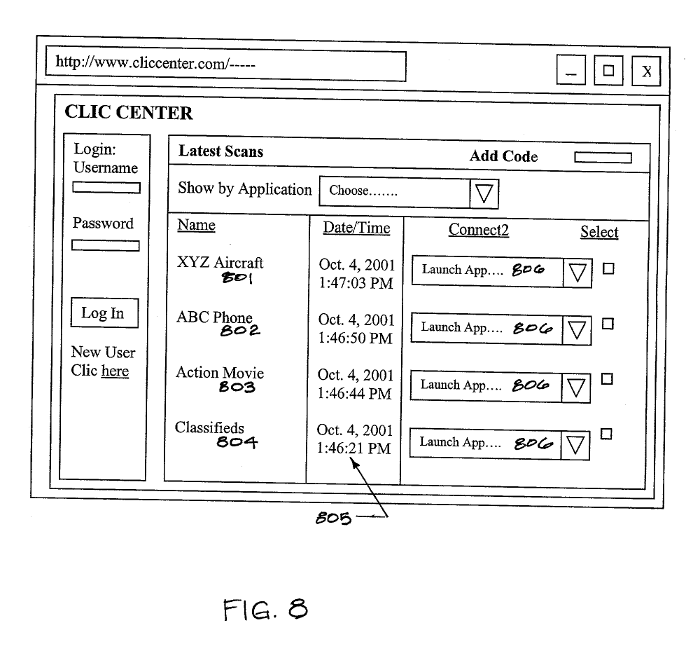

The menu options presented to the end user 500 may be set by the publisher 600 or content provider 200 according to the type of printed content to which the menu relates. For example, as shown in FIG. 5A, where the printed content is a news article, the menu options may include “Save and Share” 521, “Get More Information” 522, “Get Breaking News” 523, “Read the Company's Perspective” 524, “Learn About The Author” 525, and/or “Write (Or Read) Letters to the Editor” 526 (the latter two options being shown in FIG. 5B, which illustrates an exemplary menu presented to a user accessing platform 100 via a personal computer). In another example, as shown in FIG. 6A, a code 610 may be included in an advertisement 620 for a mobile phone. With reference to FIG. 6B, the menu options presented to a user who scans the code 610 may include “Buy” 631, “Learn” 632, and/or “Find a Location” 633. In still another example in which the code 710 is printed in a classified advertisement (FIG. 7A), the menu option presented to a user who scans the code 710 may include “Respond” 733, as illustrated in FIG. 7B.

In other preferred embodiments, the menu items presented to the user are tailored according to the circumstances surrounding the use of the inventive system. For example, the context associated with the user involves any characteristic that may be used to segment users into groups, such as characteristics of the user (e.g., the preferred language of the end user); the device employed by the user (e.g., the storage and display capabilities of the device); and/or the service context (e.g., subscribers to an on-line version of a newspaper, as opposed to subscribers to a print version of a newspaper). The context-tailored menu may be presented to the user automatically based upon data provided prior to or contemporaneously with the providing of the code. In other embodiments, the context-tailored menu may be presented in response to an intermediate menu selection made by the user through which the user specifies or implies the context.

Thus, for example, a user may present a code that the user collected from a printed medium published for consumption in the United States of America. The menu presented to this user may include only those options available in the United States and exclude those options that would be available to a user who retrieves the same code from a publication from another country. By way of further example, a user employing an Internet-enabled mobile telephone may only be presented with menu options that do not involve display of graphics, which the mobile telephone would not be capable of handling. In still another example, a code printed in association with a particular food item is scanned. The menu presented to the user may include options relating to the user's preferred grocery store or to food items meeting certain dietary restrictions of the user (as indicated by the user upon registration).

After being presented with the menu, the user may then select an item from the menu and be connected with the desired electronic content. Returning to the example illustrated in FIG. 5A, upon selecting option 1 indicating that he wants to “Save and Share” 521 the article, the user may be presented with screen 560 shown in FIG. 5C. The user may then select an email address associated with an individual with whom to share the article from a personal address book, or he may enter a new address. The user may also add a note to the message. The email may be sent as being from the user's email address that was provided to the service provider during user registration and is in standard massage format.

Returning again to FIG. 5B (depicting a menu presented to a user accessing platform 100 via a personal computer), the user may select option 2, indicating a desire to “Get More Information” 522 about the company identified in the article. Upon selecting option 2, the user may be directed to screen 561 shown in FIG. 5D, providing additional information about the company featured in the article. The user may also select option 3 of FIG. 5B indicating a desire to “Get Breaking News” 523 on the topic of the article. Upon selecting option 3, the user may be presented with screen 562 of FIG. 5E. The user may elect to obtain breaking news on the topic with any selected level of frequency. Upon selecting option 4 of FIG. 5B, “Read the Company's Perspective” 524, the user may be presented with screen 563 of FIG. 5F, showing the company's perspective on the article. Referring now to FIG. 5B, the user may select the “Learn About the Author” option 525. Upon selecting this option, the user may be directed to screen 564 of FIG. 5G, where the user can learn information about the author of the article. Finally, upon selecting the “Write or Read a Letter to the Editor” option 526 of FIG. 5B, the user may be directed to screen 565 of FIG. 5H, where the user can prepare a letter to the editor.

Other menu items relating to an article may include, with reference to FIG. 5I, “Send Article Via Electronic Messaging” 566, such as instant messaging; “Discuss the Article” 567, such as on a message board (as illustrated in FIG. 5J) or in a chat room (as illustrated in FIG. 5K); “Obtain A License” 568 (as illustrated in FIG. 5L); and/or “Deliver Information Relating to Article” 569 (as illustrated in FIG. 5M). Other options for treatment of the article may be available to the user, such as those described in U.S. patent application Ser. No. 09/812,865, which is incorporated herein by reference.

Referring now to the menu displayed upon inputting a code associated with an advertisement in FIG. 6B, upon selecting “Buy” option 631, the user may be presented with screen 634 of FIG. 6C, where the user can purchase the item advertised. Upon selecting the “Learn” option 632 of FIG. 6B, the user may be presented with screen 635 of FIG. 6D, where the user can learn more information about the item advertised. Finally, upon selecting “Find a Location” option 633 of FIG. 6B, the user may be directed to screen 636 of FIG. 6E, where the user can find the locations at which the advertised item can be purchased.

Referring now to the menu presented to the user upon inputting a code associated with a classified advertisement in FIG. 7B, the user may select “Respond” option 733. Upon selecting this option, the user may be presented with screen 734 of FIG. 7C, where the user can respond to the classified advertisement and submit the user's resume, by way of example. In another embodiment, the classified advertisement relates to items that are for sale. For example, with reference to FIG. 7D, a code 734 has been included in a classified advertisement 735. Upon scanning on the code, the user is presented screen 736, which includes a menu with several options. In particular, the user can elect to purchase the item for sale by selecting “Buy This Car” option 737 or receive more information about the item by selecting “More Information” option 738.

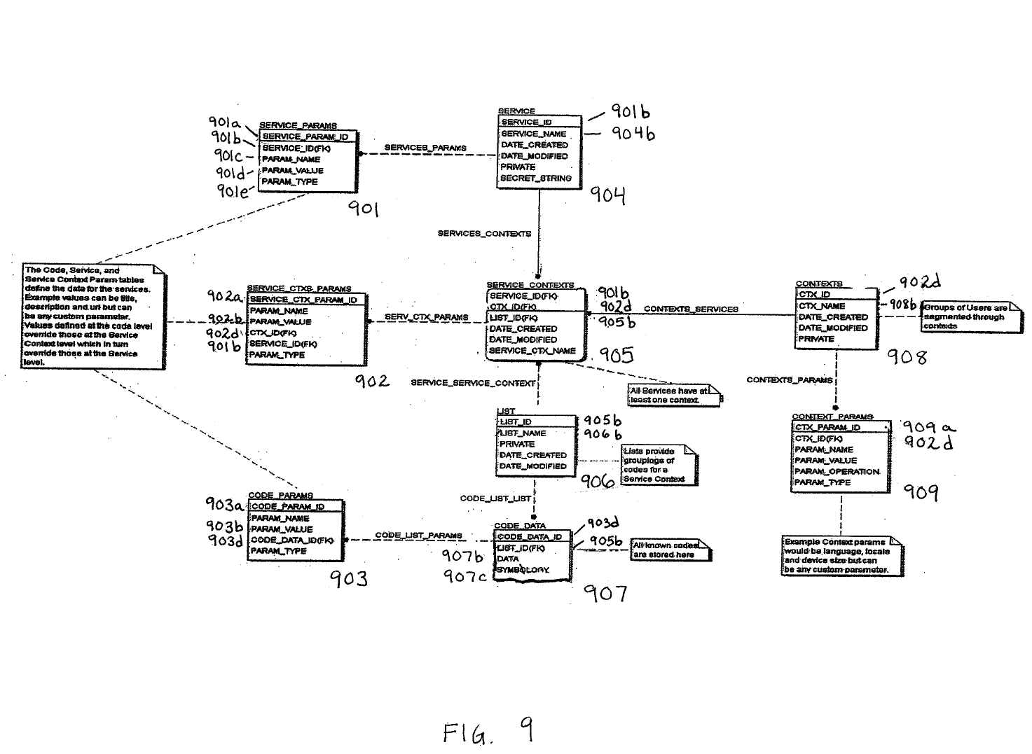

As referenced previously, as an alternative to the user being automatically connected to the menu upon input of the code, the codes scanned or otherwise inputted by the user may be stored for the end user at platform 100 and accessed by the user at a later time. For example, with reference to FIG. 8, the user previously scanned and has uploaded to platform 100 a total of four (4) codes, each associated with a different item of printed content. The codes are related to an article 801 regarding XYZ Aircraft; an advertisement 802 regarding ABC Phone; a piece 803 regarding Action Movie; and a classified advertisement 804. Also provided is the time and date 805 that each code was scanned. The codes may then be processed by the application selected by the user in dialog box 806. Upon processing, the user may be presented with one of a number of different types of menus. As discussed previously, the particular menu presented to the user may be dictated by the type of printed content with which the code is associated (e.g., article, product or service advertisement or classified); the type of device being used by to launch the application (e.g., mobile telephone, PDA, or personal computer); and/or other context parameters applied. For example, upon processing the code associated with the Action Movie, a menu may be presented to the user showing theatre and show-time options that are limited based upon the user's geographic location indicated by the user during registration with platform 100.

As is apparent from the foregoing description, various types of data are stored, retrieved and used in connection with the implementation of the present invention. An exemplary data structure for organizing such data is illustrated in FIG. 9. The service parameters table 901, service contexts parameters table 902, and code parameters table 903 store the data used in connection with the menus. For example, these tables may store URLs, email addresses, titles, descriptions, customized name/value pairs and/or any other parameters that may be used in connection with menus, as described in more detail below. Such values may, in the preferred embodiment, be subject to a hierarchical control structure. In particular, values defined at the code level (table 903) override those at the service context level (table 902); and values at the service context level override those at the service level (table 901).

Thus, for example, the user enters the system with a code and context information. Using the code, the inventive system will find all the service contexts that have created some association with that code. Then, using the context information associated with the user, the system filters out the service contexts that do not apply based on the context. Given the resulting set of service contexts, the system merges all the service parameters (from table 901), service context parameters (from table 902) and code parameters (from table 903), using the hierarchy specified above, to identify the parameters that will govern the menu displayed to the user.

With reference to service parameters table 901, each service parameter identifier 901a has associated with it a service identifier 901b, parameter name 901c, parameter value 901d, and parameter type 901e. Parameter name 901b may be a name given to a particular URL (e.g., Company ABC home page); parameter value 901d may be the URL (e.g., www.companyabc.com); and parameter type 901e may indicate that the parameter is a URL. Service identifier 901b may be used to obtain more information about the service from service table 904 (described in more detail below). With reference to service contexts parameters table 902, each service context parameter identifier 902a is associated with the parameter name, value and type (as in service parameters table 901), as well as a context identifier 902d and a service identifier 901b. Context identifier 902d and service identifier 901b can be used to obtain more information about the service context from service context table 905 (described in more detail below). Code parameters table 903 associates a code parameter identifier 903a with the parameter name, value and type (as in service parameters table 901 and service contexts parameters table 902). Code parameters table 903 also includes code data identifier 903d, which may be used to obtain further information about the codes from code data table 907 (described in more detail below).

Details about the service identified in service parameters table 901 (service identifier 901b) can be obtained from service table 904. Service table 904 includes information about the entity that creates the menu (e.g., the publisher or content provider). The details in service table 904 may include the service name 904b and the date it was created and modified. Different contexts for each service can be defined. Details relating to the context associated with a particular context identifier 902d can be obtained from contexts table 908. For example, the context name 908b, the date the context was created and modified, and whether the context is private may be obtained from contexts table 908. With reference to context parameters table 909, context parameter values for a particular context parameter identifier 909a can be determined, such as the context identifier 902d with which the context parameter is associated, the name, value, operation and type of parameter. Types of parameters include language, locale and device size, but other custom parameters can be used. A value for a language type parameter may be “French”. The operation for this parameter may be to display only menu items associated with electronic content that are written in French. A value for a device size type parameter may be “Small.” The operation for this parameter may be to display only menu items associated with electronic content that does not include graphics. A value for the locale type parameter may be “United States.” The operation for this parameter may be to display only menu items associated with electronic content displayed in the English language.

For a given context and service identified in service context parameters table 902 (context identifier 902d and service identifier 901b), details about the service context can be obtained from service contexts table 905. The service context table allows for the association of groups of codes with a particular service and context within the service. The details in service context table 905 may include a list identifier 905b (which identifies the grouping of codes associated with the particular service context), the date the service context was created and modified, and the name of the service context.

Data relating to the list identified by list identifier 905b of service contexts table 905 can be obtained from list table 906. In particular, the list name 906b can be identified, as well as an indication of whether the list is private, and the date the list created and modified. In a preferred embodiment, all codes used in connection with the inventive system are associated with one or more lists. Each list includes one or more codes that share a common characteristic relating to a particular service context. For example, all UPC numbers corresponding to grocery items may be grouped into a list of codes used in connection with an Internet application for facilitating grocery shopping. By way of further example, all custom codes purchased or reserved by a particular customer for inclusion in their publication may be grouped and included in another list.

Additional data about the code identified in table 903 (code data identifier 903d) can be obtained from code data table 907. In particular, the identity of the list to which the code belongs (list identifier 905b), the data 907b associated with the code (e.g., the code number), and the symbology 907c of the code (e.g., UPC, EAN, custom code) can be determined.

Thus, for example, a user approaching platform 100 from a particular service (service name 904b of service table 904) may be directed to a particular URL (parameter value 901d of service parameters table 901). However, if the same user approaches platform 100 from a particular context (context name 908b of contexts table 908), (identified by the context identifier 902d and service identifier 901b of table 905), the user may be directed to the URL identified by parameter value 902b of service contexts parameters table 902; this URL may be the same or different as the URL identified in service parameters table 901. Still further, the code uploaded by this user to platform 100 may dictate directing the user to yet another URL. In particular, code data table 907 is consulted to determine the code data identifier 903d associated with the uploaded code (i.e., data 907b). Code parameters table 903 is consulted to determine the URL (i.e., parameter value 903b) associated with the code data identifier 903d.

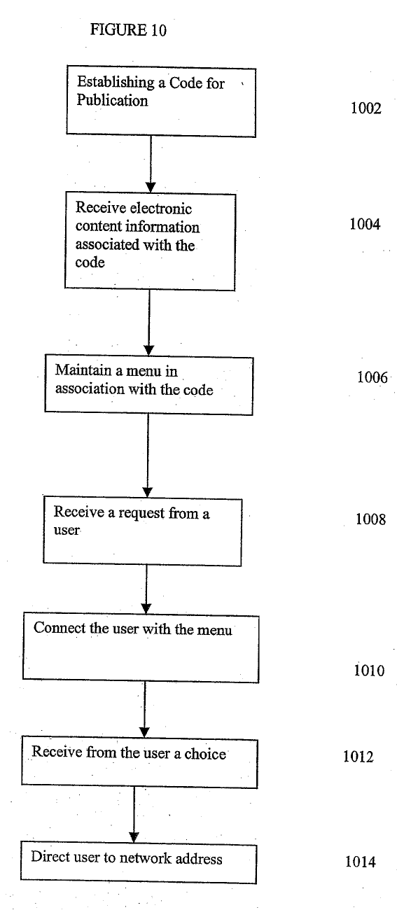

FIG. 10 illustrates a preferred embodiment of a method of the present invention. In step 1002, a code is established for publication in association with the tangible content. Those code may be established by a service provider who, for example, distributes the code to a publisher.

In step 1004, electronic content information is received. In the preferred embodiment, the electronic content information is received over the Internet by the service provider from the electronic content provider. The received information may include, for example, a network address of some electronic content, such as a URL or email address. Electronic content may be written documents, images, sounds, or any other content that can be stored electronically on a network. The information received also includes one or more content options that may be in the form of a menu of items to be presented to the end user.

In step 1006, a menu is maintained in association with the code. In the preferred embodiment, the menu is maintained by the service provider. In other embodiments, the menu may be maintained by third parties such as electronic content providers. The menu, in the preferred embodiment, includes content options received from the content providers, as discussed elsewhere herein. In step 1008, a request that includes the code is received from a user.

In step 1010, the user is connected with the menu. In the preferred embodiment, the service provider connects the user with the menu stored at the hub site. The user is then with the menu serves and asked to select one of the menu options. The user's choice is received in step 1012. In the preferred embodiment, the choice is received by the service provider. Based on the choice, the user is directed to the electronic content, in step 1014, by connecting the user to the network address.

Although the foregoing description is directed to the preferred embodiments of the invention, it is noted that other variations and modifications will be apparent to those skilled in the art, and may be made without departing from the spirit or scope of the invention.

What is claimed is:

1. A method of associating electronic content with tangible content embodied in a tangible information medium comprising:
establishing a code for publication in association with the tangible content;
receiving electronic content information associated with the code, the electronic content information comprising a network address associated with the electronic content, and at least one content option;
maintaining a menu in association with the code, the menu comprising the at least one content option;
receiving from a user, a request that comprises the code;
based on the request, connecting the user with the menu;
receiving from the user a choice comprising a selection of one of the content options; and
based on the choice, directing the user to the network address.

2. The method of claim 1 wherein receiving the request comprises receiving the request over a global communications network.

3. The method of claim 1 wherein the tangible content comprises a news article.

4. The method of claim 3 wherein the one or more content options comprise an option to save the article.

5. The method of claim 3 wherein the one or more content options comprise an option to deliver the article.

6. The method of claim 5 wherein the option to deliver the article comprises sending the article via electronic messaging.

7. The method of claim 3 wherein the one or more content options comprise an option to discuss the article.

8. The method of claim 7 wherein the option to discuss the article comprises posting a comment on a message board.

9. The method of claim 7 wherein the option to discuss the article comprises communicating via interactive messaging.

10. The method of claim 3 wherein the one or more content options comprise an option to obtain a license relating to the article.

11. The method of claim 3 wherein the one or more content options comprise an option to deliver information related to the article.

12. The method of claim 3 wherein the one or more content options comprise an option to order breaking news related to the article.

13. The method of claim 3 wherein the article is associated with a subject and the one or more content options comprise an option to receive information relating to a perspective on the subject.

14. The method of claim 3 wherein the article has at least one or more authors and wherein the one or more content options comprise an option to receive information related one or more of the authors.

15. The method of claim 3 wherein the article has at least an editor and wherein the one or more content options comprise an option to deliver a letter to the editor, and an option to read letters to the editor.

16. The method of claim 1 wherein the tangible content comprises an advertisement related to a matter.

17. The method of claim 16 wherein the one or more content options comprise an option to purchase the advertised matter.

18. The method of claim 17 wherein the matter comprises at least one product and the one or more content options comprise an option to receive information about the product.

19. The method of claim 17 wherein the matter comprises at least one service and the one or more content options comprise an option to receive information about the service.

20. The method of claim 18 wherein the information about the product comprises information about where to buy the product.

21. The method of claim 19 wherein the information about the service comprises information about where to buy the service.

22. The method of claim 1 wherein the tangible content comprises a classified advertisement.

23. The method of claim 22 wherein the classified advertisement is related to a sale and the one or more content options comprise an option to purchase based on the classified advertisement.

24. The method of claim 22 wherein the one or more content options comprise an option to receive information about the classified advertisement.

25. The method of claim 22 wherein the one or more content options comprise an option to respond to the classified advertisement.

26. The method of claim 1 wherein connecting the user with the menu is further based on a context.

27. The method of claim 26 wherein the context is a characteristic of one or more of the user, a user device, a publisher, and a content provider.

28. A system for mediating content exchange over a network comprising:
one or more databases that maintain a menu, comprising at least one content option, associated with a code, wherein the code is associated with tangible content of a publisher; and maintain an association between the at least one content option and electronic content identified by a network address; and
one or more servers that receive a signal comprising the code from a user employing a device via the network; present the menu to the user; receive from the user a selected content option from the menu; and direct the user to selected electronic content identified by a selected network address associated with the selected content option.
